(19) United States
(12) Patent Application Publication
(10) Pub. No.: US 2011/0018992 A1
(43) Pub. Date: Jan. 27, 2011

(54) Monitoring device having waterproof structure

(76) Inventor: Da-Ming Liu, Xindian City (TW)

Correspondence Address: BACON & THOMAS, PLLC, 625 SLATERS LANE, FOURTH FLOOR, ALEXANDRIA, VA, 22314-1176, US

(21) Appl. No.: 12/458,749

(22) Filed: Jul. 22, 2009

(51) Int. Cl. H04N 7/18

(52) U.S. Cl. 348/135; 348/E07.085

(57) ABSTRACT

The present invention is to provide a monitoring device comprising a body, an image capture module and a corrugated pipe having an outer periphery covered by a waterproof layer and two ends connected to the body and image capture module respectively, wherein the image capture module includes a waterproof sleeve having an end away from the corrugated pipe and provided with a lens glass, and a printed circuit board disposed in the sleeve and provided with a camera element and a transmission line passing through the corrugated pipe and extended to connect with a control module of the body, and a signal connection line is connected to the body, so that a user can connect the monitoring device to an electronic device via the signal connection line, and extends the image capture module connected on the corrugated pipe into a zigzag, moist and dark environment for monitoring the condition therein.

### FIELD OF THE INVENTION

The present invention relates to a monitoring device, more particularly to a monitoring device having a waterproof structure capable of extending into a zigzag, moist and dark environment for monitoring the condition in the environment.

### BACKGROUND OF THE INVENTION

Presently, water and fuel gas are essentials for daily life of human being. Most of tap water or fuel gas used by general users is distributed to their homes through underground water pipes or fuel gas pipes. Generally, types of pipes include metal pipes, concrete pipes, plastic pipes etc., wherein the share of the metal pipes is highest, and the plastic pipes is secondly high. However, no matter what type of pipes is used, the pipes may be broken due to the effect of external forces (such as unsuitable construction process, extrusion, erosion etc.) in use, or be jammed due to sludge or debris (such as hairs, kitchen waste etc.). As a result, when the users find that one of foregoing problems occurs in their household pipes and cannot be solved, they generally ask the help of maintenance plumbers to avoid the inconvenience caused by the breakage or jam of the pipes.

Traditionally, for finding a breakage position of the pipe under the ground or in the wall, the maintenance plumber firstly conjectures the rough location of the pipe corresponding to the actual leakage position of water or fuel gas under the ground or in the wall, and then destroys the ground or the wall corresponding to the suspected leakage position on the pipe. After finding the correct location of the pipe, and drilling a hole on the pipe, then the maintenance plumber observes or monitors the dark hole to determine the rough breakage position (i.e. the leakage position of water or fuel gas) of the pipe by a mirror, a miniature microphone or other devices. After this, the maintenance plumber digs the ground (or the wall) and the pipe corresponding to the breakage position for gradually finding out the actual breakage position of the pipe. In such a way, the procedure of maintaining and repairing the pipe will be finally finished, wherein all of holes broken on the ground or the wall for finding out the breakage position will be filled in turn, while the broken pipe will be replaced. Therefore, the operational efficiency of the maintenance plumber can not be improved, and the client may complain of the too many breaking operations of the ground (or the wall) and the pipe.

Furthermore, for the jammed condition of the pipe, the maintenance plumber uses an electric machine of removing barriers in the pipe, wherein the electric machine is provided with a barrier-removing line which can be extended into the jammed pipe by the maintenance plumber. Then, the electric machine is started to shake the barrier-dredging line in the pipe for stirring, splitting the sludge or debris deposited in the pipe, so as to dredge out the barriers in the pipe. However, if the barriers can not be split and the volume thereof is large, the maintenance plumber still needs to find the position of the barriers in the pipe by the foregoing pipe destruction method for removing the barriers, in order to surely dredge the pipe. However, the operation efficiency and the complain problem of the client still can not be improved, as described above.

As a result, it is important for related manufacturers and designers of monitoring devices having a waterproof structure to think how to develop a new monitoring device having a waterproof structure to improve the serious disadvantage that the maintenance plumber must destroy the ground (or the wall) and the pipe in turn to find out the breakage position of the pipe or the jammed position of the barriers in the pipe when the maintenance plumber traditionally repairs the broken pipe and removes large barriers in the pipe resulting in a difficulty to efficiently enhance the operation efficiency of the maintenance plumber and the possible complain problem of the client, so that the maintenance plumber can monitor the monitoring device to speedily determine the breakage position of the pipe or the barrier position in the pipe for carrying out the corresponding operational procedures (such as: dredging the water pipe, filling the broken hole thereof etc.).

It is therefore tried by the inventor to develop a monitoring device having a waterproof structure to solve the foregoing problems existing in the traditionally manual method derived from guessing to determine the environmental conditions, as described above, wherein the user (such as the maintenance plumber) can use the monitoring device of the present invention to extend into a zigzag, moist and dark environment (such as a water pipe), so as to determine the environmental conditions (such as jammed condition, breakage position etc.) for the purpose of carrying out the corresponding operational procedures (such as dredging the water pipe, filling the broken hole thereof etc.).

### SUMMARY OF THE INVENTION

An object of the present invention is to provide a monitoring device having a waterproof structure, which comprises a body, a corrugated pipe, an image capture module and a signal connection line, wherein the corrugated pipe has two ends connected to the body and the image capture module, respectively, while the corrugated pipe has an outer periphery covered by a waterproof layer. The image capture module has a waterproof sleeve and a printed circuit board, wherein the sleeve has an end which is away from the corrugated pipe and provided with a lens glass. The printed circuit board is disposed in the sleeve and provided with a camera element, at least one light emitting element and a transmission line thereon, wherein the transmission line is passed through the corrugated pipe and extended to connect with a control module of the body for transmitting control signals from the control module (such as signals of starting/stopping to capture a video, signals of starting/stopping to emit a light etc.), supplying electric power or transmitting image data captured by the camera element. The signal connection line is connected to the body, so that a user can connect the monitoring device to an electronic device (such as a notebook computer) via the signal connection line, and then the image capture module connected on the corrugated pipe can be extended into a zigzag, moist and dark environment. Thus, the control module can be operated to control the camera element to execute a monitoring operation (such as capturing a video or a picture) under a light source provided by the light emitting element, so as to precisely determine the condition of the environment. As a result, the user can conveniently execute the corresponding operational procedures, so that the operational efficiency of the user can be efficiently enhanced.

Another object of the present invention is to provide a monitoring device having a waterproof structure, wherein the image capture module is provided with a light blocking washer between a periphery of the camera element and the lens glass for blocking the light source provided by the light emitting element toward the camera element. Therefore, when the image capture module is used to execute a monitoring operation for an environment and the light emitting element is used to emit the light source for increasing the brightness of the environment by the user, the light blocking washer can efficiently prevent an over-exposure problem of an image captured by the camera element because the light source directly illuminates the camera element when the camera element captures a video or a picture.

Further another object of the present invention is to provide a monitoring device having a waterproof structure, wherein the monitoring device is further provided with a positioning module which can be fixed on the image capture module and has a magnet. Hence, when the user uses the image capture module to execute a monitoring operation for an environment and the positioning module is close to a metal article (such as a metal pipe), the magnet of the positioning module can attract and position to the metal article, so that the camera element can stably capture an image of the metal article for the user to clearly observe the condition of the metal article (such as jammed condition, breakage position etc.).

### BRIEF DESCRIPTION OF THE DRAWINGS

The invention as well as a preferred mode of use, further objectives and advantages thereof will be best understood by reference to the following detailed description of an illustrative embodiment when acquire in conjunction with the accompanying drawings, wherein:

FIG. 1 is a schematic view of a monitoring device having a waterproof structure according to a preferred embodiment of the present invention;

FIG. 2 is an exploded perspective view of an image capture module according to the preferred embodiment of the present invention; and

FIG. 3 is an operational view of the monitoring device having the waterproof structure according to the preferred embodiment of the present invention.

### DETAILED DESCRIPTION OF THE PREFERRED EMBODIMENT

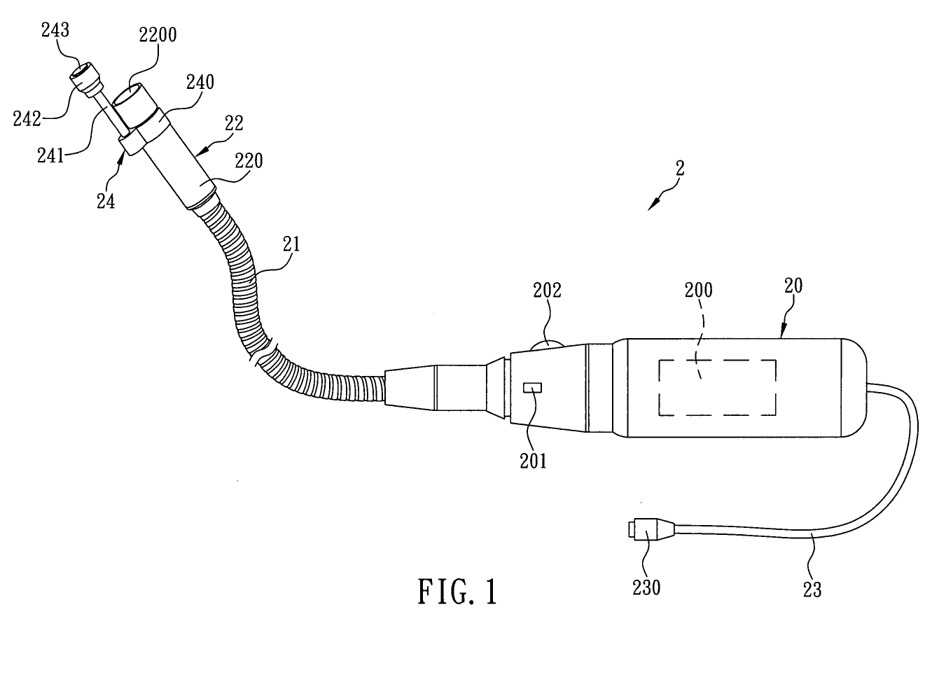

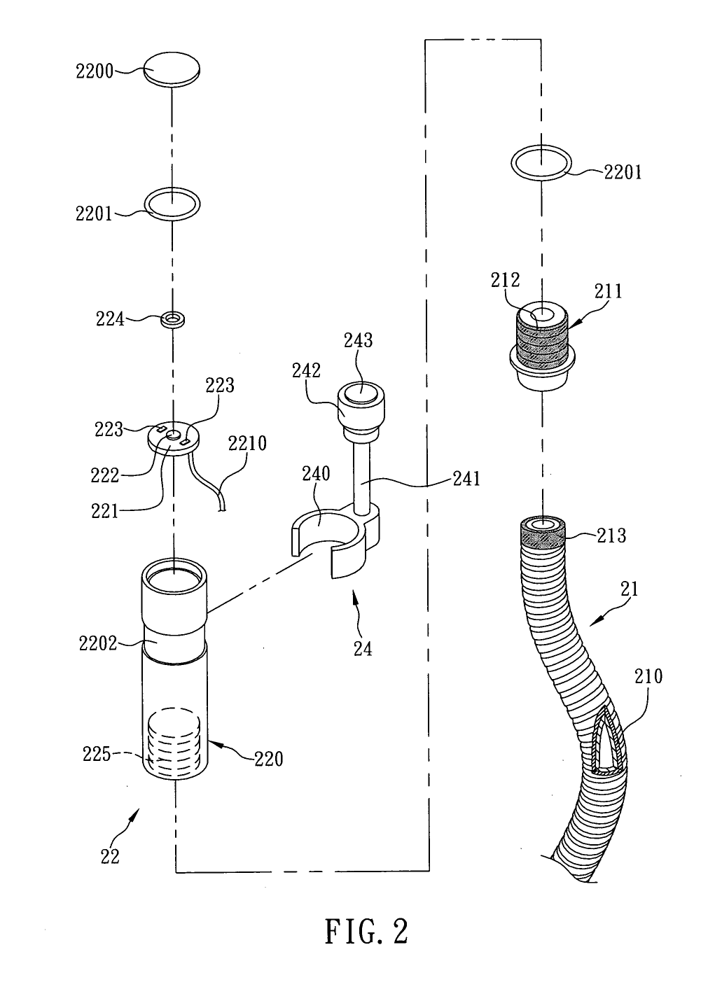

The present invention is a monitoring device having a waterproof structure. Referring now to FIGS. 1 and 2, a preferred embodiment of the present invention is illustrated. As shown, the monitoring device 2 comprises a body 20, a corrugated pipe 21, an image capture module 22 and a signal connection line 23, wherein the corrugated pipe 21 has a first end connected to a first end of the body 20, while the corrugated pipe 21 has an outer periphery covered by a waterproof layer 210. The image capture module 22 has a sleeve 220, a printed circuit board 221, a camera element 222 and at least one light emitting element 223. The sleeve 220 has a first end connected to a second end of the corrugated pipe 21, and the sleeve 220 has a second end covered with a lens glass 2200. The sleeve 220 has two waterproof washers 2201 disposed on two connection positions connected to the corrugated pipe 21 and the lens glass 2200, respectively. Thus, the sleeve 220 can be defined with a gastight space therein for preventing water from entering the sleeve 220, so that the sleeve 220 can be a waterproof sleeve. The printed circuit board 221 is disposed in the sleeve 220 and provided with a transmission line 2210 thereon, wherein the transmission line 2210 is passed through the corrugated pipe 21 and extended to connect with a control module 200 of the body 20 for transmitting control signals from the control module 200 (such as signals of starting/stopping to capture a video, signals of starting/stopping to emit a light etc.), supplying electric power or transmitting image data captured by the camera element 222. The camera element 222 and each said emitting element 223 are disposed on a surface of the printed circuit board 221 facing the lens glass 2200. The signal connection line 23 has a first end inserted into a second end of the body 20, and connected to the control module 200 for supplying the electric power to the control module 200, or transmitting the image data captured by the camera element 222. The signal connection line 23 has a second end extended outward to form a signal connection port 230, wherein the signal connection port 230 can be a USB connection port or a 1394 connection port.

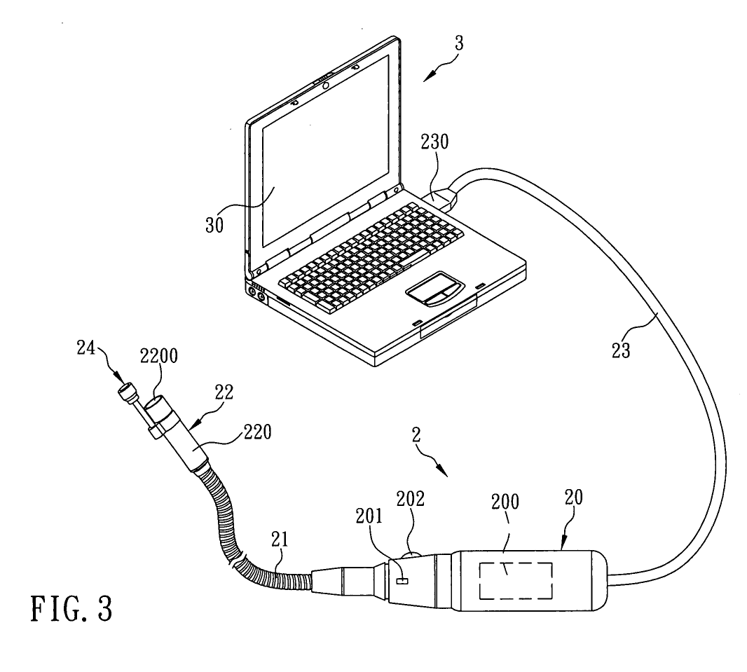

Thus, referring now to FIGS. 1, 2 and 3, when a user (such as a maintenance plumber) connects the monitoring device 2 to an electronic device 3 (such as a notebook computer) via the signal connection port 230 of the signal connection line 23, the image capture module 22 connected on the corrugated pipe 21 can be extended into a zigzag, moist and dark environment (such as a water pipe) by the user. Thus, the control module 200 can be operated to control the camera element 222 to execute a monitoring operation (such as capturing a video or a picture) under a light source provided by the light emitting element 223. Then, the video or picture can be shown on a display 30 of the electronic device 3, so as to precisely determine the condition of the environment (such as jammed condition, breakage position etc.). As a result, the user can conveniently execute the corresponding operational procedures (such as: dredging the water pipe, filling the broken hole thereof etc.), so as to efficiently enhance the operational efficiency of the user and to solve the problems existing in the traditionally manual method derived from guessing to determine the environmental conditions, as described above.

In the embodiment, referring back to FIGS. 1 and 2, the body 20 has an outer periphery provided with a switch key 201 and a light adjustment key 202, wherein the switch key 201 and the light adjustment key 202 are electrically connected to the control module 200, respectively. When the user presses the switch key 201, the switch key 201 triggers the control module 200, so that the control module 200 sends a control signal of capturing an image to the camera element 222. When the user adjusts the light adjustment key 202, the light adjustment key 202 triggers the control module 200, so that the control module 200 sends a control signal of adjusting the brightness of the light emitting element 223. As a result, when the monitoring device 2 is used in the moist and dark environment, the user can use the switch key 201 and the light adjustment key 202, wherein the light adjustment key 202 is firstly used to control each of the at least one light emitting element 223 to emit a light source to illuminate the moist and dark environment, and then the switch key 201 is pressed to start to capture an image, so that the user can conveniently use the monitoring device 2 to capture the image and observe the condition of the environment.

In addition, referring still to FIGS. 1 and 2, in the embodiment, the image capture module 22 is provided with a light blocking washer 224 between a periphery of the camera element 222 and the lens glass 2200 for blocking the light source provided by the light emitting element 223 toward the camera element 222. Thus, when the image capture module 22 is used to execute a monitoring operation of an environment and the light emitting element 223 is used to emit light for increasing the brightness of the environment by the user, the light blocking washer 224 can efficiently prevent an over-exposure problem of an image captured by the camera element 222 because the light source directly illuminates the camera element 222 when the camera element 222 captures a video or a picture. Meanwhile, it also can prevent the light source from refracting and reflecting to the camera element 222 via the lens glass 2200, so as to avoid the image captured by the camera element 222 from generating a halo phenomenon. Thus, the present invention can substantially enhance the definition and yield of the image captured by the monitoring device 2, so that the user can precisely determine the condition of the environment.

Furthermore, in the embodiment, referring to FIGS. 1 and 2 again, the monitoring device 2 is further provided with a positioning module 24 which comprises a clamping element 240, a shaft 241 and a magnet 243, wherein the clamping element 240 can engage a groove 2202 formed around an outer periphery of the sleeve 220. The shaft 241 has a first end connected to the clamping element 240, while the shaft 241 has a second end extended in a direction away from the corrugated pipe 21 to form a fixing base 242. The magnet 243 is installed on the fixing base 242. Thus, when the user uses the image capture module 22 to execute a monitoring operation of an environment and the positioning module 24 is close to a metal article (such as a metal pipe), the magnet 243 of the positioning module 24 can attract and position to the metal article, so that the camera element 222 can stably capture an image of the metal article for substantially enhance the definition and yield of the image captured by the monitoring device 2. As a result, the user can clearly observe the condition of the metal article (such as jammed condition, breakage position etc.).

Referring again to FIGS. 1 and 2, in the embodiment, a first end of a first threaded unit 211 is connected to the second end of the corrugated pipe 21 while a silicone layer 213 is embedded between the outer surface of the second end of the corrugated pipe 21 and the inner surface of the first end of the first threaded unit 211. Besides, a second threaded unit 225 engageable with the outer surface of a second end of the first threaded unit 211 is provided at the inner surface of the first end of the sleeve 220 so as for the first end of the sleeve 220 to be firmly connected to the second end of the corrugated pipe 21 via the second threaded unit 225. Moreover, the outer surface of the second end of the first threaded unit 211 is coated with a layer of waterproof glue 212. Thus, when the corrugated pipe 21 and the sleeve 220 are connected tightly together by means of the threaded units 211, 225, the waterproof glue 212 fills up gaps between the threaded units 211, 225, and the waterproof silicone layer 213 is tightly embedded between the outer surface of the second end of the corrugated pipe 21 and the inner surface of the first end of the first threaded unit 211, so as to enhance waterproofness of the monitoring device 2 and effectively increase applicability and service life of the monitoring device 2.

Therefore, as described above, referring back to FIGS. 1 and 2, the monitoring device 2 of the present invention enables the user to precisely determine the condition of a zigzag, moist and dark environment (such as jammed condition, breakage position etc.) for the purpose of carrying out the corresponding operational procedures (such as: dredging the water pipe, filling the broken hole thereof etc.). Thus, the operational efficiency of the user can be efficiently enhanced, so as to solve the problems existing in the traditionally manual method derived from guessing to determine the environmental conditions, as described above.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A monitoring device having a waterproof structure, the monitoring device comprising:
a body;
a corrugated pipe having a first end connected to a first end of the body, and provided with an outer periphery covered by a waterproof layer;
an image capture module having:
a sleeve having a first end connected to a second end of the corrugated pipe and a second end covered with a lens glass, and having two waterproof washers disposed on two connection positions connected to the corrugated pipe and the lens glass, respectively, so as to be a waterproof sleeve;
a camera element disposed on a surface of the printed circuit board facing the lens glass;
at least one light emitting element each disposed on the surface of the printed circuit board facing the lens glass;
a printed circuit board disposed in the sleeve and provided with a transmission line thereon, wherein the transmission line is passed through the corrugated pipe and extended to connect with a control module of the body for transmitting control signals from the control module, and supplying electric power, or transmitting image data captured by the camera element; and
a signal connection line having a first end connected to the control module and a second end extended to form a signal connection port for connecting to an electronic device.

2. The monitoring device having the waterproof structure according to claim 1, wherein the body has an outer periphery provided with a switch key which is electrically connected to the control module, so that the control module sends a control signal of capturing an image to the camera element upon the switch key being pressed.

3. The monitoring device having the waterproof structure according to claim 1, wherein the outer periphery of the body is provided with a light adjustment key which is electrically connected to the control module, so that the control module sends a control signal of adjusting brightness of the light emitting element upon the light adjustment key being adjusted.

4. The monitoring device having the waterproof structure according to claim 2, wherein the outer periphery of the body is provided with a light adjustment key which is electrically connected to the control module, so that the control module sends a control signal of adjusting brightness of the light emitting element upon the light adjustment key being adjusted.

5. The monitoring device having the waterproof structure according to claim 3, wherein the image capture module is provided with a light blocking washer between a periphery of the camera element and the lens glass for blocking the light source provided by the light emitting element toward the camera element.

6. The monitoring device having the waterproof structure according to claim 4, wherein the image capture module is provided with a light blocking washer between a periphery of the camera element and the lens glass for blocking the light source provided by the light emitting element toward the camera element.

7. The monitoring device having the waterproof structure according to claim 5, wherein the monitoring device is further provided with a positioning module which comprises:
a clamping element engaging a groove formed around an outer periphery of the sleeve;
a shaft having a first end connected to the clamping element and a second end extended in a direction away from the corrugated pipe to form a fixing base; and
a magnet installed on the fixing base, so that the magnet of the positioning module attracts and positions a metal article upon the positioning module becoming close to the metal article, and the camera element stably captures an image of the metal article.

8. The monitoring device having the waterproof structure according to claim 6, wherein the monitoring device is further provided with a positioning module which comprises:
a clamping element engaging a groove formed around an outer periphery of the sleeve;
a shaft having a first end connected to the clamping element and a second end extended in a direction away from the corrugated pipe to form a fixing base; and
a magnet installed on the fixing base, so that the magnet of the positioning module attracts and positions a metal article upon the positioning module becoming close to the metal article, and the camera element stably captures an image of the metal article.

9. The monitoring device having the waterproof structure according to claim 7, wherein the second end of the corrugated pipe is connected to a first end of a first threaded unit, a silicone layer is embedded between the outer surface of the second end of the corrugated pipe and the inner surface of the first end of the first threaded unit, and a second threaded unit engageable with the outer surface of a second end of the first threaded unit is provided at the inner surface of the first end of the sleeve so as for the first end of the sleeve to be firmly connected to the second end of the corrugated pipe via the second threaded unit.

10. The monitoring device having the waterproof structure according to claim 8, wherein the second end of the corrugated pipe is connected to a first end of a first threaded unit, a silicone layer is embedded between the outer surface of the second end of the corrugated pipe and the inner surface of the first end of the first threaded unit, and a second threaded unit engageable with the outer surface of a second end of the first threaded unit is provided at the inner surface of the first end of the sleeve so as for the first end of the sleeve to be firmly connected to the second end of the corrugated pipe via the second threaded unit.

11. The monitoring device having the waterproof structure according to claim 9, wherein the outer surface of the second end of the first threaded unit is coated with a layer of waterproof glue.

12. The monitoring device having the waterproof structure according to claim 10, wherein the outer surface of the second end of the first threaded unit is coated with a layer of waterproof glue.

13. The monitoring device having the waterproof structure according to claim 11, wherein the signal connection port is a USB connection port.

14. The monitoring device having the waterproof structure according to claim 12, wherein the signal connection port is a USB connection port.

15. The monitoring device having the waterproof structure according to claim 11, wherein the signal connection port is a 1394 connection port.

16. The monitoring device having the waterproof structure according to claim 12, wherein the signal connection port is a 1394 connection port.
